(19) United States
(12) Patent Application Publication
(10) Pub. No.: US 2025/0327483 A1
(43) Pub. Date: Oct. 23, 2025

(54) ASSEMBLY FOR TORSIONAL VIBRATION REDUCING APPARATUS

(71) Applicant: UNIPRES CORPORATION, Yokohama-shi, Kanagawa (JP)

(72) Inventors: Daiki KAKEHI, Fuji-shi (JP); Yutaka MURATA, Fuji-shi (JP); Atsushi KOBAYASHI, Fuji-shi (JP); Ryuta MORI, Fuji-shi (JP)

(73) Assignee: UNIPRES CORPORATION, Yokohama-shi, Kanagawa (JP)

(21) Appl. No.: 18/855,790

(22) PCT Filed: Apr. 13, 2023
(86) PCT No.: PCT/JP2023/015019

§ 371 Date: Oct. 10, 2024

(30) Foreign Application Priority Data
Jul. 21, 2022 (WO) PCT/JP2022/028327

(51) Int. Cl. F16D 3/12; F16D 3/66

(52) U.S. Cl. CPC F16D 3/12; F16D 3/66; F16D 2300/22

(57) ABSTRACT

An assembly for a torsional vibration reducing apparatus. An input member connected to the drive source and the output member connected to the transmission are a single-steel plate of the press-formed products. Coil springs are arranged to elastic-fluctuate according to the rotational fluctuation between the input and output members. On the both end portions of the coil springs, retainers which are injection molding products from the resin material for holding the coil springs, are mounted. The retainers have a fitting structure by the groove-projection and a supporting structure of a face-to-face between an opposite surface in the axial direction and an opposite surface in the radial direction against the input and output member, and the supporting structure to the input and output members by the retainers themselves is realized.

### TECHNICAL FIELD

The present invention relates to an assembly for a torsional vibration reducing apparatus.

### BACKGROUND ART

In a vehicle that an internal-combustion engine is a prime mover, a technique depending on elastic deformation of coil springs arranged with intervals in a circumferential direction as a torsional vibration reducing apparatus, is well known. Each of the coil springs is arranged between circumferential opposite surfaces between an input member of the prime mover side and an output member of wheels side. The elastic deformation of the coil springs is aroused in accordance with a rotational fluctuation between the input member and the output member, and the elastic force of the coil springs which become great in accordance with the enlargement of the rotational fluctuation contributes to the suppression of the rotational fluctuation (the torsional vibration).

Conventionally, in this type torsional vibration reducing apparatus, the input member and the output member are press-formed products made by steel plates, the input member is made by two plates so as to form a container of the coil springs between the opposite surfaces, the periphery is fixed by rivets or the like and the output member is arranged in the middle so as to basically form with the three iron plates. It may be sometime formed by many steel plates. The respective coil springs have retainers at both end portions in the circumferential direction and are held under initial load in a coil-spring container of the input member via the retainers at both ends. The output member has coil-spring driving sections opposite to respective end portions in the circumferential direction of the coil springs, and the coil-spring driving sections arouse the further elastic deformation in accordance with the direction based on the rotational fluctuation between the input member and the output member so as to reduce the rotational fluctuation (refer to Patent Documents 1 to 3).

### The List of Prior Documents

### Patent Documents

Patent Document 1: Japanese Unexamined Patent Publication No.2002-13547 A
Patent Document 2: Japanese Unexamined Patent Publication No. 2002-257195 A
Patent Document 3: Japanese Unexamined Patent Publication No. 2012-159111 A

### SUMMARY OF THE INVENTION

### Problems to be Solved by the Invention

The conventional technique is an integrated structure as the input member that the input side is the press-formed product made by at least two steel plates, and the containers of the coil springs are formed at equal intervals in the circumferential direction between the two steel plates and are fixed by the rivets or the like. Consequently, there are defects that not only parts number increases but the manufacturing process becomes complicated. Further, the use of the rivet is a disadvantage in view of the suppression of the outer size of the products. Furthermore, since the adoption of the rivet causes the limit of a torsional angle, this will also become disadvantage. The torsional angle is a magnitude of the rotational fluctuation to be capable of suppression.

The present invention has been developed in view of the above-described technical problems of the prior art, and an object of the present invention is to greatly reduce the parts number by respectively configuring the input member and the output member with one piece material and by combining the supporting structure to the retainer for the input member and the output member while retaining the supporting function of the original coil springs.

### Means for Solving the Problems

The present invention is that: the assembly for a torsional vibration reducing apparatus that comprises an input member to be rotatably connected to driving side, an output member which has a same rotation central line to the input member and is rotatably connected to driven side, and coil springs arranged in a circumferential direction with intervals between the input member and the output member; and reduces a rotational fluctuation at a driving time of the output member of the driven side based on the input member of the driving side by an elastic deformation of the coil springs in a circumferential direction: wherein either one of the input member and the output member is faced to the coil springs with equal intervals in a circumferential direction and has a same rotation central line to the input member and the output member, and includes an annular disc which has an arc-shaped guide portion in an inner periphery having engaging sections at both sides in a circumferential direction; and another one of the input member and the output member includes a central supporting plate, axial-direction extending boards formed to be extended in an axial direction at one side of a radial outer side of the supporting plate, overhang boards which extend between the coil springs closing to radial outer side of the supporting plate in a circumferential direction and has pressurization sections at both sides in a circumferential direction, and retainers mounted on both sides in circumferential direction of the respective coil springs, wherein the respective retainers comprise: a bottomed recess which is formed at a corresponding overhang board and a circumferential-direction separation-side end portion, and contains and supports a circumferential-direction end portion closing to the coil springs; a guide groove which is extended to in a circumferential direction at outer circumferential side, includes a pair of side surfaces in a circumferential direction opposite to an axial direction and a bottom in a circumferential direction, and is freely fit in a circumferential direction to an arc-shaped guide portion; a circumferential-direction wall portion which is biased to an axial-direction same-side for an axial-direction extending board mounting-side of the supporting plate at inner peripheral side by leaving an opposite surface to a supporting-plate circumference surface, and which is oppositely formed on the supporting plate in an axial direction; a pressure receiving section which is flatly formed on a circumferential-direction end portion closing to the overhang board; a first axial-direction supporting-surface forming portion to form a first axial-direction supporting-surface established on the pressure receiving section; a second axial-direction supporting-surface forming portion which is established separated from the first axial-direction supporting-surface forming portion in an axial direction, and forms a second axial-direction supporting-surface on an extension of a supporting-surface plate opposite-surface of the circumferential-direction wall portion; and a circumferential-direction supporting-surface forming portion which is biased to radial inner side and is established on the pressure receiving section while biased to a mounting side of the axial-direction extending board to the supporting plate and an axial-direction same side, and forms the circumferential-direction supporting-surface in a radial outer side, and wherein the respective retainers make contact with the engaging section and the pressurization section opposite to the pressure receiving section, for the supporting plate, are made contact with the first axial-direction supporting-surface from one side of an axial direction and are made contact with the second axial-direction supporting-surface from another side, the circumferential-direction supporting surface is made contact with the axial-direction extending board from a radial inner side and the respective coil springs are compressed to set loads between the retainers in a circumferential direction so that the retainers themselves support the input member and the output member.

The assembly in the first embodiment of the present invention is that: wherein the overhang boards are formed so as to extend to a radial outer side from the axial-direction extending board, wherein the first axial-direction supporting-surface forming portion is established from the pressure receiving section and is formed as plate-like projection to be terminated on a way from a retainer circumference surface to radial inner side, and the first axial-direction supporting surface is formed by axial-direction separation side-surface from the supporting plate of the plate-like projection, wherein the second axial-direction supporting-surface forming portion and the circumferential-direction supporting-surface forming portion are integrated and are formed as arc-shaped projections established at the pressure receiving section separated from plate-like projections in a radial inner side and biased to axial-direction separation side from the supporting plate, and the second axial-direction supporting-surface is formed by axial-direction closing-side end face of supporting plate closing side of the arc-shaped projection and the circumferential-direction supporting-surface is formed by radial outer side surface of the arc-shaped projection, wherein the overhang board makes contact with the axial-direction supporting portion in the plate-like projection and the supporting plate makes contact with the second axial direction supporting surface in the arc-shaped projection, and wherein the arc-shaped projection penetrates into the axial-direction extending board from a radial inner side and the circumferential-direction supporting-surface makes contact with inner circumferential surface of the axial-direction extending board. And, the assembly in this embodiment is that: wherein trapezoidal projection is established on the pressure receiving section so as to terminate on a way from a circumference surface by biasing in parallel with the plate-like projection in a radial direction and to supporting plate closing side, and wherein longitudinal groove opened to the guide groove is formed between the plate-like projection and the trapezoidal projection, in a neutral state that there is no rotational fluctuation between the input member and the output member, a circumferential-direction end portion corresponding to the arc-shaped guide portion of the annular disc is contained in the longitudinal groove and makes contact with the pressure receiving section.

The assembly according to another embodiment is that: wherein the overhang boards (in following, a first overhang boards) in the another one of the input member and the output member are extended in an axial direction toward a separation side from the first overhang boards so as to double use the axial-direction extending board (in following, a first axial-direction extending board), wherein the one of the input member and the output member comprises, in addition to the annular disc, a second supporting plate aligned to the supporting plate (in following, a first supporting plate), a second overhang board aligned to the input member and the first overhang board in an axial direction, and a second axial-direction extending board that is integrally connected to the second supporting plate to a radial-direction overhang inner-edge between the arc-shaped guide portions neighboring to the annular disc in a circumferential direction, wherein the first axial-direction supporting-surface forming portion biases in a radial inner side and is formed in the pressure receiving section as the trapezoidal projection biased and established at the first supporting plate closing side in an axial direction, and the first axial-direction supporting surface is formed by the first supporting plate of the trapezoidal projection and separation-side surface, wherein the second axial-direction supporting-surface forming portion and the circumferential-direction supporting-surface forming portion are integrated and are formed as the arc-shaped projection separated from the trapezoidal projection in an axial direction and established at the pressure receiving section by biasing to the first supporting plate and separation side, and the circumferential-direction supporting-surface is formed by the radial outer surface of the arc-shaped projection, and wherein the outer circumferential-side end portion of the first supporting plate makes contact with the first axial-direction supporting surface and the second axial-direction supporting surface between the trapezoidal projection and the arc-shaped projection, the arc-shaped projection penetrates into the first axial-direction overhang board from radial inner side, and the circumferential-direction supporting-surface makes contact with inner circumferential surface of the axial-direction extending board.

In the another embodiment of the present invention, the circumference surface of the supporting plate among overhang boards neighboring in a circumferential direction is separated from an inner circumferential surface of the arc-shaped guide portion as separating from an edge rim of the overhang board to an intermediate portion to an edge rim opposite in a circumferential direction. The retainers form notch portions extended to the pressure receiving section side from opening edge rim of the bottomed recesses at, at least, one side wall surface in an axial direction. Further, the input member and the output member are press-formed products made by steel plates, and the retainers are plastic-integral molded products by an injection molding type.

### Effects of the Invention

The retainers-themselves have the supporting structure in an axial direction and a radial direction to the input member and the output member without having not to damage an original function to support the coil springs. Therefore, it is possible to configure the assembly for the torsional vibration reducing apparatus even though both the input member and the output member are parts made by one plate. Further, it is possible to abbreviate the bonding members of the two parts or plural parts such as the rivet and to realize the significant reduction of the parts numbers as the total.

Since the rivet is not necessary, the miniaturization of the radial direction or the space effective utilization of the radial direction becomes possible. For example, it is possible to mount the coil spring at more outside in the same outer diameter and to enhance the performance due to the magnification of the torsional angle.

Further, the retainers are capable of injection molding products made by the synthetic resins, and it is possible to reduce the undesired sound and to realize the quietness since a junction of the retainers to opposite surface of the retainers at an operating time is not metal-to-metal.

### BRIEF DESCRIPTION OF THE DRAWINGS

In the accompanying drawings:

FIG. 1 is a front view, seeing from the transmission side, of the assembly for the torsional vibration reducing apparatus of the first embodiment according to the present invention;

FIG. 2 is an aligned sectional view taken along a line II-II in FIG. 1;

FIG. 3 is a rear view, seeing from the prime mover side, of the assembly for the torsional vibration reducing apparatus of the first embodiment according to the present invention;

FIG. 4 is an aligned sectional view taken along a line IV-IV in FIG. 1;

FIG. 5 is a front view of a single product of the input member of the assembly for the torsional vibration reducing apparatus of the first embodiment according to the present invention;

FIG. 6 is a front view of a single product of the output member of the assembly for the torsional vibration reducing apparatus of the first embodiment according to the present invention;

FIG. 7A is a front view of the retainer 16;

FIG. 7B is a rear view of the retainer 16;

FIG. 7C is a right side view of the retainer 16;

FIG. 7D is a left side view of the retainer 16;

FIG. 8 is a perspective view showing respective parts of the assembly of the first embodiment according to the present invention by a decomposition state;

FIG. 9 is a partial view of FIG. 1 and an explanation diagram to explain the operation in a case that the assembly of the first embodiment of the present invention at a rotational fluctuation time is configured as the torsional vibration reducing apparatus;

FIG. 10 is a front view, seeing from the transmission side, of the assembly for the torsional vibration reducing apparatus of the second embodiment according to the present invention;

FIG. 11 is a rear view, seeing from the prime mover side, of the assembly for the torsional vibration reducing apparatus of the second embodiment according to the present invention;

FIG. 12 is an aligned sectional view taken along a line XII-XII in FIG. 10;

FIG. 13 is a front view of a single product of the input member of the assembly for the torsional vibration reducing apparatus of the second embodiment according to the present invention;

FIG. 14 is a front view of a single product of the output member of the assembly for the torsional vibration reducing apparatus of the second embodiment according to the present invention;

FIG. 15A is a front view of the retainer 116;

FIG. 15B is a rear view of the retainer 116;

FIG. 15C is a right side view of the retainer 116;

FIG. 15D is a left side view of the retainer 116; and

FIG. 16 is a perspective view showing respective parts of the assembly of the second embodiment according to the present invention by a decomposition state.

### MODE FOR CARRYING OUT THE INVENTION

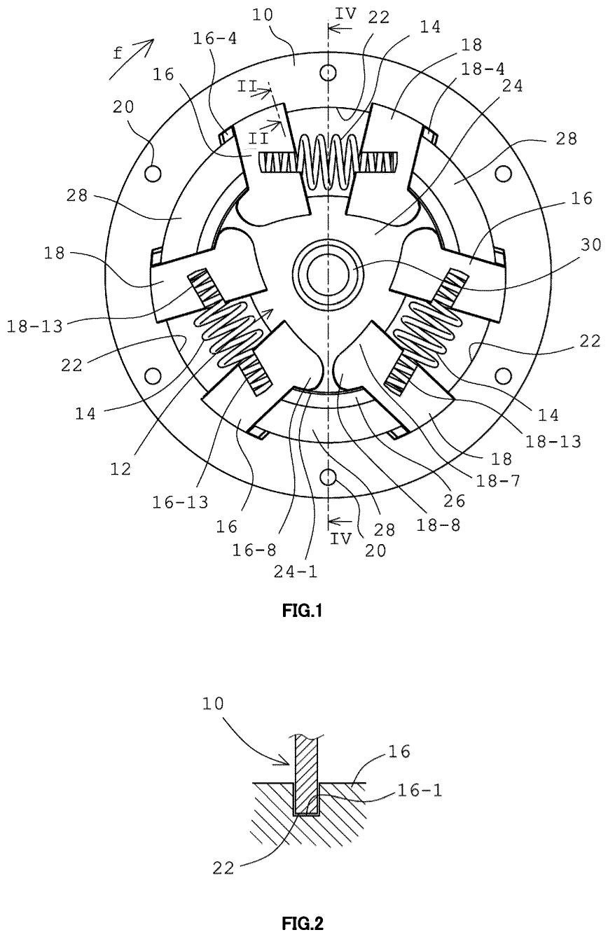

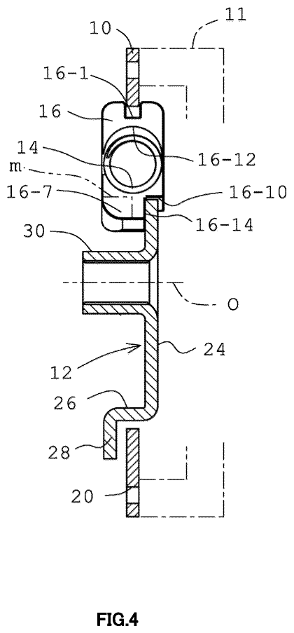

The embodiments of the present invention will be described with reference to the accompanying drawings. As shown in FIG. 1, an assembly for a torsional vibration reducing apparatus of the first embodiment of the present invention comprises an input member 10 to be connected to a flywheel (a portion is shown by an imaginary line 11 in FIG. 4) connected to a crank shaft (not shown) of an internal-combustion engine (a prime mover), an output member 12 to be connected to a transmission (not shown), plural coil springs 14 (three in the present embodiment) arranged with equal intervals in a circumferential direction, retainers 16 mounted on one end of a longitudinal direction of the respective coil springs 14, and retainers 18 mounted on an another end of a longitudinal direction of the respective coil springs 14. The retainers 16 and 18 are respectively symmetrical shapes across the coil springs 14 and are provided three sets matching to the number of the coil springs 14.

The material of the retainers 16 and 18 is synthesis resin having a mechanical strength such as nylon, and the retainers 16 and 18 may be molded-products by the injection molding type.

The retainers 16 and 18 of the present invention have supporting structure against the input member 10 and the output member 12 by oneself as in detail explained hereinafter. It is possible to obtain a self-supporting structure serving as the assembly included the coil springs 14 while the input member 10 and the output member 12 are also single item and further a connecting fitting such as a rivet is not used. Then, it is possible to establish the torsional vibration reducing apparatus by connecting the assembly to the prime mover side (the crank shaft) on the input member 10 and connecting the assembly to the transmission on the output member 12.

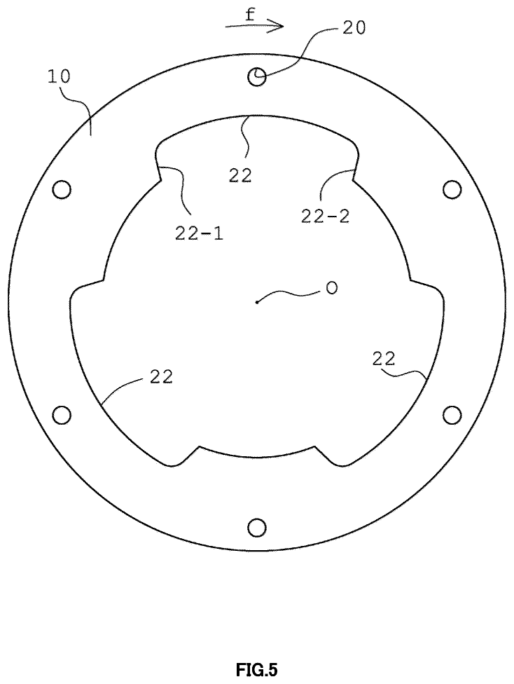

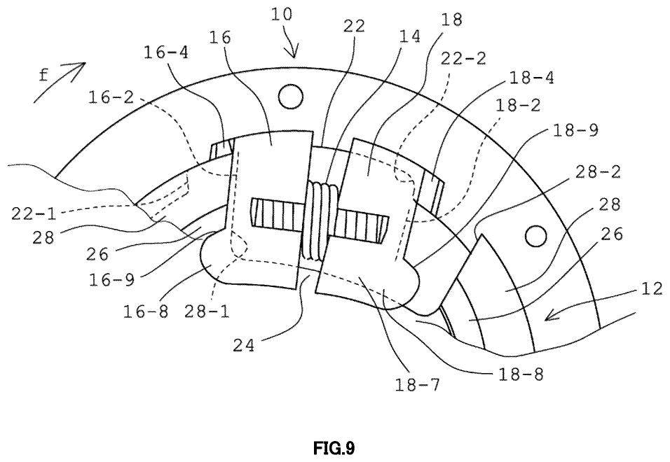

In the assembly of the present embodiment, the input member 10 is the press-formed products of which material is steel plate and is an annular disc as shown in FIGS. 5 and 8. The input member 10 has volt holes 20 to fix the flywheel on the periphery, and has three arc-shaped guide portions 22 which are formed with equal intervals on the inner circumferential surface in a circumference direction and are recessed portion with a predetermined depth. In FIG. 8, the three guide portions 22 are classified by respectively assigning the labels “A”, “B” and “C”. A group of the retainers 16 and 18 are mounted on the respective guide portions 22 as shown in FIG. 1. A rotation center of the guide portions 22 is same with the rotation central line O of the input-output axes as shown in FIG. 5 (also refer to FIG. 4), and the guide portions 22 are sliding guidance surface of the retainers 16 and 18 at the rotation fluctuation time of the input-output axes as explaining later. In a case of the torsional vibration reducing apparatus comprised by connecting the input member 10 to the crank shaft and by connecting the output member 12 to the transmission, and in the neutral state that there is no rotation fluctuation between the input member 10 and the output member 12, the relative rotation of the retainers 16 and 18 is, as explaining later, stopped by end faces 22-1 and 22-2 (engaging section of the present invention) extended to the inner circumference surface in the radial direction at the both ends of the circumferential direction of the respective guide portions 22. At this time, the coil springs 14 are set to an initial load.

Although the rotational direction of the crank shaft (not shown) is a clockwise (CW) direction (an arrow f in FIG. 8), the end face 22-1 is positioned at an upstream of the rotational direction against the rotational fluctuation of the same direction (hereinafter, referred as “forward rotational direction”) of the rotational direction f of the crank shaft and the end face 22-2 is positioned at a downstream thereof. Since the rotational fluctuation is occurred in the forward rotational direction and also an opposite direction (hereinafter, referred as “reversing direction”), the end face 22-1 is positioned at the downstream and the end face 22-2 is positioned at the upstream in a case of the rotational fluctuation of the reversing direction. In the embodiment, the upstream and the downstream are relative.

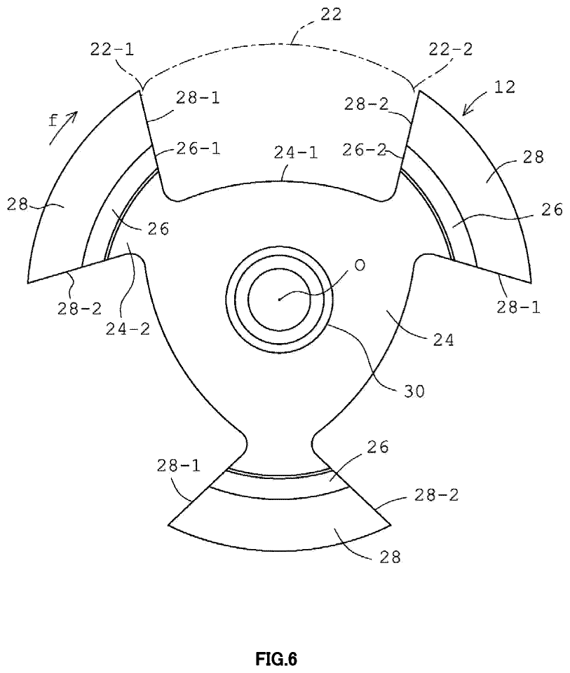

The output member 12 is also the press-formed products of which the material is the steel plate similar to the input member 10. The output member 12 has, as shown in FIGS. 6 and 8, a supporting plate 24 which is a round and pseudo triangle (Onigiri (Japanese) shape) and three overhang boards 28 which are again bended via axial-direction extending boards 26 (the first axial-direction extending board of the present invention) which are integrally bending-formed by circumference convex portions 24-2 on the peak of the triangle of the supporting plate 24 and are extended to radial outer sides (refer to FIG. 8). The respective overhang boards 28 extend toward radial outer sides and have end faces 28-1 and 28-2 (pressurization section of the present invention) opposite to the circumferential direction (also, refer to FIG. 8). The end faces 28-1 and 28-2 of the overhang board 28 neighboring in the circumferential direction form a group, and the group performs compressive deformation of the coil springs 14 corresponding to the rotational fluctuation together the end faces 22-1 and 22-2 in the circumferential direction of the guide portion 22. The three groups are provided in this embodiment in accordance with the guide portions 22, and the groups are classified by respectively assigning the signs “A”, “B” and “C” to the guide portions 22(A), 22(B) and 22(C). That is, in the respective groups comprising of the end faces 28-1 and 28-2 of the overhang board 28 neighboring in the circumferential direction, the end face 28-1 is positioned at the upstream and the face 28-2 is positioned at the downstream to the rotational fluctuation of the forward rotational direction (the arrow f direction), and the end face 28-1 is positioned at the downstream and the face 28-2 is positioned at the upstream to the rotational fluctuation of the reversing direction (opposite direction of the arrow f). The upstream and the downstream to the end faces 28-1 and 28-2 are also relative.

As is obvious from the detail explanation on the exploded perspective view of FIG. 8, in the neutral state when there is no rotational fluctuation between the input member 10 and the output member 12, the retainers 16 and 18 respectively make contact with the end faces 22-1 and 22-2 opposite to the respective guide portions 22 and further make contact with the end faces 28-1 and 28-2 opposite to the overhang board 28 neighboring in the circumferential direction, and the coil springs 14 are set to the initial load at this time. In the rotational fluctuation between the input member 10 and the output member 12, the further pressing of the coil springs 14 is performed from the set load between the end faces 28-1 and 28-2 of the guide portions 22 (the input member 10 side) opposite at the upstream and the downstream in the rotational direction and the end faces 28-1 and 28-2 of the overhang board 28 (the output member 12 side) neighboring the circumferential direction. That is, in a case that the output member 12 is rotation-fluctuated in the forward rotational direction (the arrow f direction) against the input member 10, the retainer 16 being the upstream of the rotational fluctuation leaves from the end face 22-1 of the guide portions 22 by the pressure based on the end face 28-1 of the overhang board 28, and slides along the guide portion 22 toward the retainer 18 which is a group of the downstream at the rotational fluctuation of the reversing rotation retained by the end face 22-2. Inversely, in a case that the output member 12 is rotation-fluctuated in the reversing rotational direction (opposite direction to the arrow f) against the input member 10, the retainer 18 being the downstream of the rotational fluctuation leaves from the end face 22-2 of the guide portion 22 by the pressure based on the end face 28-1 of the overhang board 28, and slides along the guide portion 22 toward the retainer 18 which is a group of the downstream at the rotational fluctuation of the reversing rotation retained by the end face 22-1. As stated above, the more pressing of the coil springs 14 is aroused by the sliding of the retainers 16 and 18 and the suppression of the rotational fluctuation is realized. The position relations among the retainers 16 and 18, the guide portions 22 and the overhang board 28 are also referred in FIG. 1.

The output member 12 further forms, on the supporting plate 24, an integral spline shaft 30 which is the same axis with the rotational central line O of the input-output axes, and the spline shaft 30 is capable of connecting to the transmission input axis (not shown) by an inner circumferential spline (not shown).

As shown in FIG. 6, the output member 12 forms a depression potion to contain the coil springs 14 among the overhang boards 28 neighboring in the circumferential direction. The bottom surface of the depression potion is formed by the circumference surface 24-1 which is one triangle-side a little extended to outside in the pseudo triangle of the supporting plate 24. The guide portion 22 of the input member 10 in the neutral state (the case that the rotational fluctuation does not exist) between the input-output axes is indicated by the single-point chain line, and the guide portion 22 and the depression potion between the overhang boards 28 form a window frame-like containing aperture to contain the single coil spring 14 corresponding to the three coil springs 14 (also, refer to FIG. 1). The circumference surface 24-1 of the supporting plate 24 being the bottom surface of the window frame-like containing aperture, slowly but surely, gradually increases the space toward central portion in the circumferential direction from the end faces 28-1 and 28-2 of the overhang boards 28 against the guide portion 22 (the inner circumferential surface) of the input member 10 sharing the rotation central line O. According to this structure, it is possible to obtain the intended sliding operation of the retainers 16 and 18 to the guide portions 22 corresponding to the rotational fluctuation in the assembled state while the mounting of the retainers 16 and 18 at an assembling time is easy. It is understood that the end faces 28-1 and 28-2 of the overhang boards 28 are face-to-face connected to the circumference convex portion 24-2 of the supporting plate 24 with the end faces 26-1 and 26-2 of the axial-direction extending boards 26. Further, in the neutral state between the input-output axes, the end faces 28-1 and 28-2 of the overhang boards 28 are smoothly engaged with the end faces 22-1 and 22-2, respectively (refer to FIG. 6).

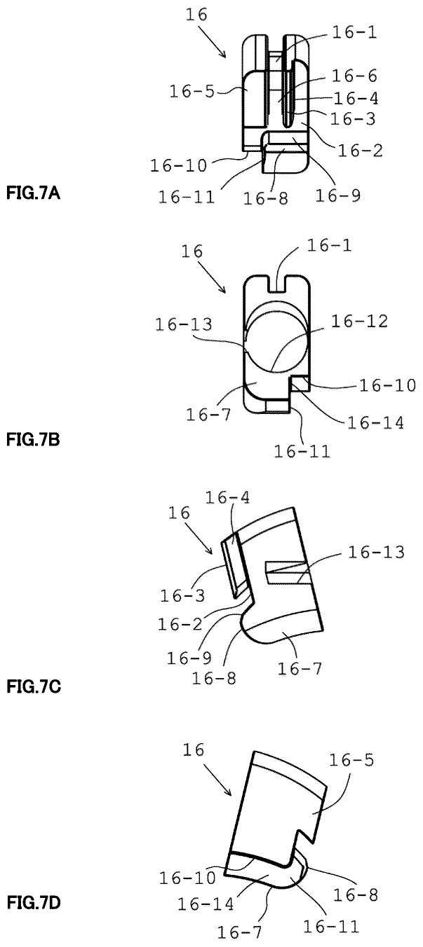

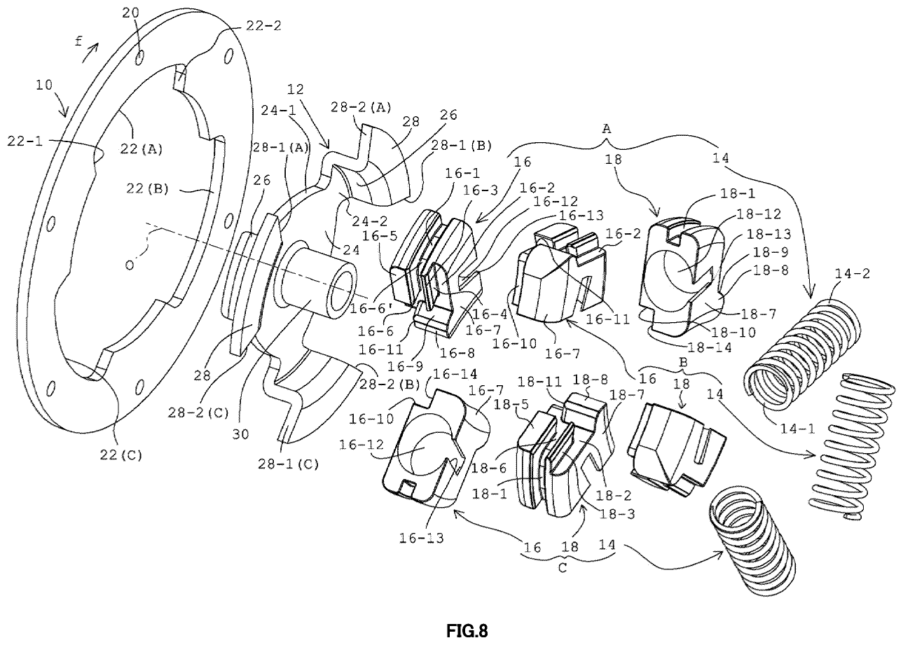

The retainers 16 and 18 form a group with opposite retainers crossing one of the coil springs 14, and the three groups respectively comprising of the retainers 16 and 18 and the coil springs 14 are indicated by the signs “A”, “B” and “C” (these groups correspond to the grouping of the guide portions 22 and the end faces 28-1 and 28-2 of the overhang boards 28) in FIG. 8, respectively. Below, the respective constructions of the retainers 16 and 18 and the assembly structure to the input member 10 and the output member of the retainers 16 and 18 with reference to FIG. 8 will be explained. In the following, the construction of the retainers 16 and 18 will be explained. However, since the one group of the retainers 16 and 18 is a symmetry construction and all construction cannot be all over viewed by one perspective figure, the retainer 16 of the group A is mainly explained with reference to another groups Band C and further by optionally referring to the single-item diagram of the retainer 16 shown in FIGS. 7A to 7D.

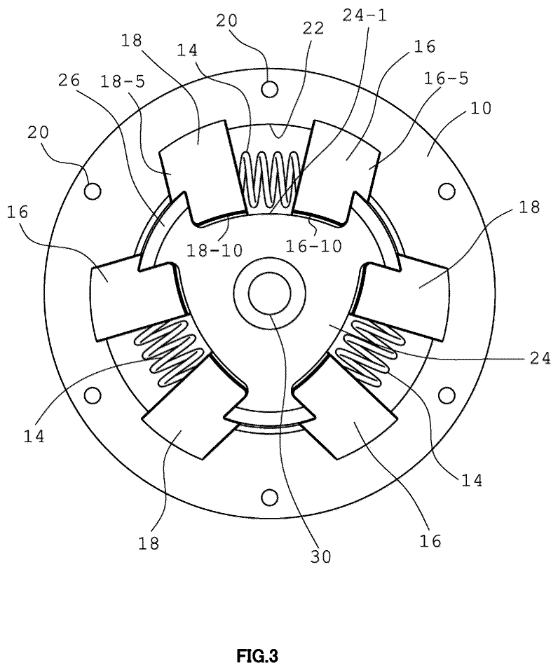

First, the relation between the retainer 16 and the input member 10 will be explained. The retainer 16 has a guide groove 16-1 (FIGS. 7A and 7B) extended spanning entire length of the circumferential direction at the circumference surface opposite to the guide portion 22 of applicable group (in this case, the group A) on the input member 10. The guide groove 16-1 has a shape of the sectional (Japanese) letter “ [symbol] ” opened to the radial outer side and is, slidably in the circumferential direction and with a suitable clearance, contained in the thickness part of the input member 10 in the guide portion 22 so that the retainer 16 is relatively rotatable in the circumferential direction to the input member 10. The bottom surface of the guide groove 16-1 extended to the circumferential direction is applicable to the supporting surface which supports the retainer 16 at the radial outer side to the input member 10. FIG. 2 shows the fitting state of the guide portion 22 (the input member 10) to the both side surfaces of the guide groove 16-1, and the side surfaces of the guide portion 22 are face-to-face opposite to the both side surfaces of the guide groove 16-1 and the bottom surface of the guide portion 22 is face-to-face opposite to the bottom surfaces of the guide groove 16-1.

The retainer 16 forms a flat surface 16-2 (a pressure receiving section of the present invention) extended, in parallel to the rotation central line O, to in the radial direction at the circumferential-direction end portion opposite to the neighboring overhang boards 28. The flat surface 16-2 makes contact with the end face 28-1 (although the shape is not easy understood from FIG. 8, refer to the shape of the end face 28-2 opposite to the circumferential direction of the retainer 18 being the group) opposite to the overhang boards 28 close to the circumferential direction, and becomes a torque receiving face from the overhang board 28 in the rotational fluctuation of the forward rotational direction (the arrow f direction).

In FIG. 8, the plate-like projection 16-3 is integrally established from the flat surface 16-2 (FIG. 7A), and the inner peripheral side of the plate-like projection 16-3 is terminated on the way while the outer circumferential side of the plate-like projection 16-3 extends face-to-face to the circumference surface. The plate-like projection 16-3 is perpendicular to the rotation central line O of the transmission side (the driven side of the present invention) and forms an axial-direction supporting surface 16-4 (FIGS. 7A and 7C) extended to the radial direction (the plate-like projection 16-3 configures the first axial-direction supporting-face forming portion of the present invention) with the axial-direction supporting surface 16-4. As stated later, in the assembled state, the overhang board 28 is made face-to-face contact with the axial-direction supporting surface at the transmission side in the axial direction, and the axial-direction supporting surface 16-4 functions as the axial-direction supporting face of the retainer 16 to the transmission side. The face-to-face contact of the overhang board 28 and the axial-direction supporting surface 16-4 in the assembled state is understood from the position relation of the axial direction (the direction orthogonal to the paper plane) between the overhang board 28 and the axial-direction supporting surface 16-4 in FIG. 1 and FIG. 9 shown later.

From the flat surface 16-2, the trapezoidal projection 16-5 is established separated against the prime mover side (the driving side of the present invention) in the axial direction from the plate-like projection 16-3, and the trapezoidal projection 16-5 is terminated in aligned to the plate-like projection 16-3 in the radial direction while the trapezoidal projection 16-5 is also face-to-face to the circumference surface of the retainer 16 and the side surface of the prime mover side. Then, the longitudinal groove 16-6 in which the bottom face is a part of the flat surface 16-2 and which is extended via the guide groove 16-1 and the curved section 16-6′ of the circumference surface, is left between the plate-like projection 16-3 and the trapezoidal projection 16-5. The curved section 16-6′ of the longitudinal groove 16-6 is added for matching to an R-shape of a root of the end face 22-1 (FIG. 5) of the guide portion 22 opposite to the circumferential direction. That is, the longitudinal groove 16-6 and the curved section 16-6′ contain the end face 22-1 in the neutral state without the rotational fluctuation, and the relative rotation of the input member 10 to the output member 12 is restrained by the flat surface 16-2.

In FIG. 8, the retainers 16 are biased to the radial direction so as to be face-to-face to the transmission side in the radial inner side, the narrow width inner periphery 16-7 (the circumferential direction wall portion of the present invention) extends in the radial direction leading up to the inner circumferential surface (regarding the whole shape of the inner periphery 16-7, refer to the retainer 16 of the group B). The inner periphery 16-7 is a face-to-face flat side-face in the transmission side. However, although the inner periphery 16-7 exceeds the longitudinal groove 16-6 at the prime mover side, and is terminated on the way and represents the steps. The inner periphery 16-7 drops back to the radial outer side of the prime mover side by the above step structure, and the bottom face 16-10 in the radial direction opposite to the circumference surface 24-1 of the supporting plate 24 and the wall surface 16-14 (the opposite surface of the supporting plate 24 of the inner periphery 16-7) in the axial direction opposite to the supporting plate 24 from the transmission side, are formed (regarding the step structure, refer to retainers 16 of the groups B and C in FIG. 8). Further, regarding the inner-side step structure of the retainer 16 in the circumferential direction, also refer to FIG. 7B being the single-item diagram of the retainer 16.

The inner periphery 16-7 forms an arc-shaped projection 16-8 established from the flat surface 16-2 spaced from the plate-like projection 16-3 and the trapezoidal projection 16-5 to the radial inner at the overhang board 28 side. That is, the arc-shaped projection 16-8 is the overhang board 28-side extending portion of the inner periphery 16-7. The arc-shaped projection 16-8 has a structure to penetrate from the inner periphery side into the axial-direction extending board 26 to connect the overhang board 28 to the supporting plate 24 (regarding the aspect that the arc-shaped projection 16-8 penetrates the axial-direction extending board 26, refer to FIG. 1). According to this structure, the circumference surface 16-9 (also refer to FIG. 7C) of the arc-shaped projection 16-8 becomes a supporting surface to support the retainer 16 from the axial-direction extending board 26 or from the radial inner side to the output member 12, and the supporting structure of the radial direction of the retainer 16 is provided with the supporting surface from the radial outer side being the bottom face of the guide groove 16-1 (the construction formed the circumference surface 16-9 at the arc-shaped projection 16-8 is equivalent to the circumferential-direction supporting-surface forming portion of the present invention). A relation between the plate-like projection 16-3 and the arc-shaped projection 16-8 forms a space portion to pass the axial-direction extending board 26 of the output member 12 in the assembled state. The arc-shaped projection 16-8 forms, in the prime mover side, the axial-direction supporting surface 16-11 (also refer to FIG. 7B) which is perpendicular to the prime mover side in the axial direction and extends to the radial direction. The axial-direction supporting surface 16-11 is opposite to the supporting plate 24 and makes contact with the supporting plate 24 in the assembled state (the neutral state), and functions as the axial-direction supporting surface to the prime mover side of the retainer 16. That is, the axial-direction supporting surface 16-11 works serving as the supporting surface to support the retainer 16 at both sides in the axial direction with the axial-direction supporting surface 16-4. Although the contacting structure of the axial-direction supporting surface 16-11 to the supporting plate 24 (the circumference convex portion 24-2) is hard to understand in the retainer 16 of the group A, it is understood based on the positional relation between the axial-direction supporting surface 16-11 of the retainer 16 of the group B and the circumference convex portion 24-2 of the supporting plate 16. The construction formed the axial-direction supporting surface 16-11 at the arc-shaped projection 16-8 is equivalent to the second axial-direction supporting-surface forming portion of the present invention. As stated above, the arc-shaped projection 16-8 is an end portion corresponding to the overhang board 28 of the inner periphery 16-7, and the axial-direction supporting surface 16-11 of the arc-shaped projection 16-8 represents the extending portion in the circumferential direction face-to-face with the wall surface of the inner periphery 16-7. These are also understood from FIG. 7B and FIG. 7D.

Although the transmission-side end face represents the face-to-face in this embodiment, the inner periphery 16-7 is capable of forming a thin plate-like projection of the radial inner-side direction by backing (an imaginary line m in FIG. 4) the inner diameter portion of the inner periphery 16-7 to the prime mover side with a suitable shaft thickness. The prime mover side-surface (the opposite surface to the supporting plate 24) of the thin plate-like projection configures the axial-direction supporting surface of the present invention.

In this embodiment, the retainer 16 has a cylindrical bottomed recess 16-12 to contain end portion 14-1 of the coil spring 14 corresponding to the circumferential-direction end portion at the mounting side of the flat surface 16-2 or to the circumferential-direction end portion separated from the end portion 28-1 and the contact side of the overhang board 28, and this matter is clearly shown in the retainer 16 of the group C in FIG. 8. Then, although the notch portion 16-13 from the end face side of the coil spring 14 is formed at the side wall portion of the transmission side of the retainer 16, the notch portion 16-13 is capable of facilitating as the inserting hole to inner side of the bottomed recess 16-12 of a jig (an assembling robot) to shrink the coil spring 14 for mounting at the assembling time.

The retainer 18 being a pair of the group A is the same with the retainer 16 except for the symmetrical structure, and there are provided the circumferential-direction sliding structure and the inner periphery 18-7 to the guide portion 22 by the guide groove 18-1, the step structure (faces 18-10 and 18-11) by the inner periphery 18-7, the arc-shaped projection 18-8, the bottomed recess 18-12 and the notch portion 18-13. It is understood that there are provided the circumferential-direction inner surface 18-10 and the wall surface 18-14 (an opposite surface to the supporting plate 24 of the inner periphery 18-7) formed by the step structure based on the inner periphery 18-7 (also refer to the retainer 18 of the group B). Regarding the retainer 18 of the group C, it is understood that there are provided the plate-like projection 18-3 and the trapezoidal projection 18-5 established at the flat pressure receiving section 18-2, the longitudinal groove 18-6 formed between them, the arc-shaped projection 18-8 of a tip portion of the inner periphery 18-7 and the axial-direction supporting face 18-11 formed by the arc-shaped projection 18-8.

Further, the configuration that the step surface 18-10 of the retainer 18 is opposite to the circumference surface 24-1 of the supporting plate 24 is shown in FIG. 3, and the configuration that the arc-shaped projection 18-8 of the retainer 18 supports the axial-direction extending board 26 (the output member 12) from the radial inner side is shown in FIG. 1. Although the transmission-side end face represents the face-to-face in this embodiment, in similar to the inner periphery 16-7 (according to a broken line m in FIG. 4), the wall surface 18-14 is capable of forming as a thin plate-like projection of the radial inner-side direction by backing the side surface separated from the supporting plate 24 of the inner periphery to the prime mover side with a suitable shaft thickness.

The mounting of the retainers 16 and 18 corresponding to the input member 10 and the output member 12 will be explained below, and the mounting of the retainer 16 will be explained by assuming the retainer 16 of the group A in FIG. 8. As explained with reference to FIG. 6, the interval between the guide portion 22 of the input member 10 and the circumference surface 24-1 of the supporting plate 24 of the output member 12 is the maximum at a center portion between the opposite end faces 28-1 and 28-2 of the overhang board 28 neighboring with the circumferential direction being the group. The retainer 16 is led to the interval between the guide portion 22 and the supporting plate 24 from the circumferential-direction inner surface (the step surface) 16-10 that the height is low by optionally inclining the retainer 16 to input member 10, and it is possible to fit the guide groove 16-1 to the guide portion 22 by straightly correcting the input member 10 and the retainer 16. In similar to the retainer 18, it is possible to fit the guide groove 18-1 to the guide portion 22 by leading the retainer 18 to the window frame-like opening from the step surface 18-10 side. In the state that the retainers 16 and 18 are fit to the guide portion 22, the retainers 16 and 18 are opposite to the circumferential-direction outside surface 24-1 of the supporting plate 24 in the radial direction at the step surfaces 16-10 and 18-10 and are opposite to the supporting plate 24 at the wall surfaces 16-14 and 18-14 in the axial direction from the transmission side (also refer to FIG. 4). Therefore, the retainers 16 and 18 become the supported states in the axial direction from the transmission side.

Then, when the retainer 16 already fit to the guide portion 22 is pushed into the end face 22-1 opposite to the guide portion 22 in the circumferential direction, the overhang board 28 is engaged with the plate-like projection 16-3 at the transmission side in the output member 12 while the longitudinal groove 16-6 of the retainer 16 is fit to the end face 22-1 of the guide portion 22 in the input member 10. Further, the axial-direction extending board 26 is led between the trapezoidal projection 16-5 and the arc-shaped projection 16-8, the axial-direction supporting surface 16-11 of the arc-shaped projection 16-8 meets the circumference convex portion 24-2, and the arc-shaped projection 16-8 is fit to the axial-direction extending board 26 from inside. In the final pushing completed-state, the longitudinal groove 16-6 is fit to the end face 22-1, and the end face 28-1 of the overhang board 28 is made contact with the flat surface 16-2 of the retainer 16. In this state, the circumferential-direction inner surface (the bottom surface) 16-10 of the retainer 16 is closely opposite to the circumferential-direction outside surface 24-1 of the supporting plate 24 of the input member 12 (refer to FIG. 3). Regarding the retainer 18, the flat surface 18-2 of the retainer 18 is made contact with the end face of the overhang board 28 in the state that end face 22-2 of the guide portion 22 is fit to the longitudinal groove 18-6 by the same operation. In this state, the circumferential-direction inner surface 18-10 of the retainer 18 is closely opposite to the circumferential-direction inner surface 24-1 of the supporting plate 24 of the output member 12, and the retainer 18 is supported to the axial direction and the radial direction to the input member 10 and the output member 12. At this time, the notch portions 16-13 and 18-13 are respectively opposite to the retainers 16 and 18 of the groups (refer to FIG. 1). The coil spring 14 shortened by the jig is led between the retainers 16 and 18 by inserting the jig via the notch portions 16-13 and 18-13, and the both end portions 14-1 and 14-2 are respectively mounted on the bottomed recesses 16-12 and 18-12 by backing the jig via the notch portions 16-13 and 18-13.

As stated above, the assembly of the present embodiment that the coil springs 14 are held in the circumferential-direction opposite surfaces between the input member 10 and the output member 12 via the retainers 16 and 18, is obtained.

In the assembly of the present embodiment, the retainers 16 and 18 have a self-contained-type supporting structure that the retainers-themselves are held in the axial direction and the radial direction to the input member 10 and the output member 12 respectively comprising one plate material without injuring the original function to hold at the circumferential direction both sides of the coil springs 14. That is, regarding this supporting structure, the retainer 16 will be explained that: the guide groove 16-1 is fit to the guide portion 22 of the input member 10, and an opposite surface separated in the axial direction of the guide groove 16-1 is supported to the input member 10 in the axial direction (FIG. 2). Further, the axial direction support to the output member 12 of the retainer 16 is performed by contacting the overhang board 28 with the plate-like projection 16-3 (the axial-direction supporting surface 16-4) of the retainer 16 from the transmission side and by contacting the supporting plate 24 (the circumference convex portion 24-2) with the axial-direction supporting surface 16-11 (formed on the arc-shaped projection 16-8) of the retainer 16 from the prime mover side. In addition, the radial direction support is performed by contacting the guide portion 22 of the input member 10 with the bottom surface (FIG. 2) of the guide groove 16-1 of the retainer 16 from the radial-direction outer side and by contacting (also refer to FIG. 1) the circumference surface 16-9 of the arc-shaped projection 16-8 with the inner circumferential surface of the axial-direction extending board 26 of the output member 12 from the radial-direction inner side.

Further, the support to the input member 10 and the output member 12 is similar to the above structure. The retainer 18 is supported to the input member 10 in the axial direction by contacting the guide groove 18-1 with the axial-direction opposite side surface, and the retainer 18 is supported to the output member 12 in the axial direction between the plate-like projection 18-3 and the arc-shaped projection 18-8 (the axial-direction supporting surface 18-11). Furthermore, the radial direction support of the retainer 18 is performed by contacting the guide portion 22 of the input member 10 with the bottom surface of the guide groove 18-1 of the retainer 18 from the radial-direction outer side and by contacting the circumference surface 18-9 of the arc-shaped projection 18-8 with the axial-direction extending board 26 of the output member 12 from the radial-direction inner side.

Since the retainers 16 and 18 are the self-contained type supporting structure to the input member 10 and the output member 12, both the input member 10 and the output member 12 are one item of the press-formed products from the steel plate. In spite of this structure, the retainer 16-itself is supported at the input member 10 and the output member 12 in the axial direction and the radial direction, and the original function to hold the coil springs 14 is not injured. In comparison with the conventional structure that the input member 10 is a two-plate structure and the coil springs are held between the two plates, it is possible to save at least one of the press-formed products. The rivet is not necessary caused by the integration of the two-plate structure, and it is possible to suppress the parts number and also is advantage in view of the workability. It is possible to improve the flexibility of a design at the radial outer side since the rivet is not used.

In the above embodiment, although the retainers 16 and 18 form the notch portions 16-13 and 18-3 (the jig leading hole for pressing the springs (14) at the assembling time) at only one side of the axial direction, it is also possible to form the notch portions 16-13 and 18-3 at both sides in the axial direction of the retainers 16 and 18.

The operation of the torsional vibration reducing apparatus that the assembly of the first embodiment is connected to the fly wheel 11 (the crankshaft side) on the input member 10 and is connected to the transmission on the output member 12 side, will be explained. In a case (the neutral state) that there is no rotational fluctuation between the input member 10 and the output member 12, the retainer 16 makes contact, for the flat surface 12, with the end face 22-1 of the guide portion 22 on the input member 10 and the end face 28-1 of the overhang board 28 on the output member 12 in the state that the guide groove 16-1 is fit to the guide portion 22. Further, the retainer 18 makes contact, for the flat surface 18-2, with the end face 22-2 of the guide portion 22 on the input member 10 and the end face 28-2 of the overhang board 28 on the output member 12 in the state that the guide groove 18-1 is fit to the guide portion 22. At this time, the coil springs 14 are compressed with the set load and this neutral state is shown in FIG. 1.

FIG. 9 shows a case that the rotational fluctuation to the forward rotational direction (the arrow f direction in FIG. 9) of the output member 12 to against the input member 10 is occurred in the torsional vibration reducing apparatus comprising the assembly of the first embodiment. The overhang board 28 makes the retainer 16 sliding toward the arrow f direction (the clock-wise) of FIG. 9 along the guide portion 22 due to the contact of the end face 28-1 with the flat surface 16-2 opposite to the retainer 16, the retainer 16 is left from the contact state with the end face 22-1 of the guide portion 22, and the engagement between the end face 28-1 of the overhang board and the flat surface 16-2 of the retainer 16 becomes stronger. Regarding the retainer 18 being another group, the flat surface 18-2 maintains the contacting state with the guide portion end face 22-2 of the downstream side of the rotational fluctuation direction. In this connection, the end face 28-2 of the overhang board 28 of the downstream side in the rotational fluctuation direction is left from the flat surface 18-2 of the opposite retainer 18, and the further compression of the coil springs 14 between the retails 16 and 18 is aroused. Based on the increasing of the relative rotation toward the forward rotational direction (the arrow f direction) of the output member 12 to the input member 10, the overhang board 28 in the downstream of the rotational fluctuation direction of the output member 12 is soon left from the retainer 18 (the longitudinal groove 18-6 in FIG. 8) and the axial-direction extending board 26 is left from the arc-shaped projection 18-8 (the circumference surface 16-9 of the circumferential direction). At this time, since the retainer 18 is engaged under the elastic force with the guide portion end face 22-2 at the flat surface 18-2, the retainer 18 is fixed on the input member 10. In addition, the radial-outer side component of the elastic force caused by the coil springs 14 and the centrifugal force caused in the retainer 18 by the rotation of the crank shaft contribute to the secure holding of the retainer 18 to the input member 10.

Inversely, in a case that the output member 12 rotationally fluctuates to the inverse direction (the opposite direction to the arrow f) from the neutral state to the input member 10, the overhang board 28 inversely makes the retainer 18 sliding along the guide portion 22 via the guide groove 18-1 by contacting end face 28-2 with the flat surface 18-2. At this time, the flat surface 18-2 of the retainer 18 is left from the contacting state with the end face 22-2 of the guide portion 22, and the engagement of the end face 28-2 of the overhang board 28 against the flat surface 18-2 of the retainer 18 being the group becomes stronger. Since the flat surface 16-2 of the retainer 16 is fixed to the end face 22-1 of the guide portion 22, the retainer 18 is slid toward the retainer 16 opposite in the circumferential direction along the guide portion 22 via guide groove 18-1 while the end face 28-1 of the overhang board 28 leaves from the retainer 16, and the further compression of the coil springs 14 is aroused. It is possible to realize the reduction of the rotational fluctuation according to the compression operation of the coil springs 14 corresponding to the direction of the rotational fluctuation.

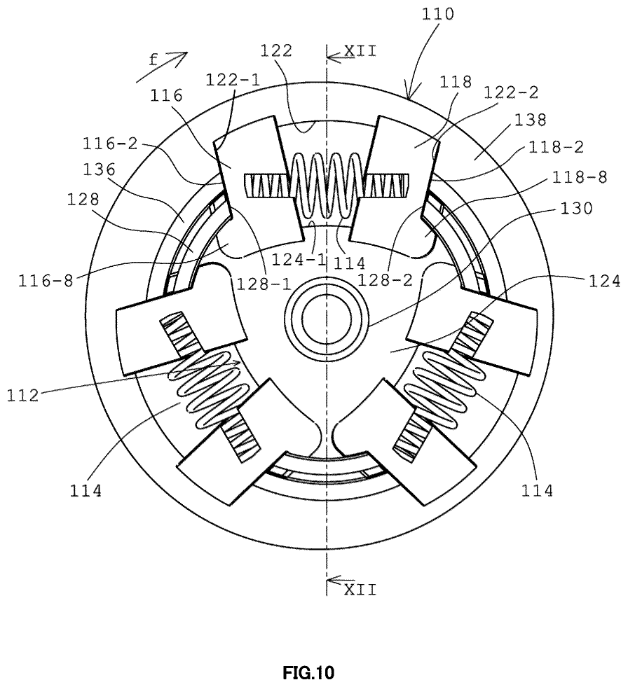

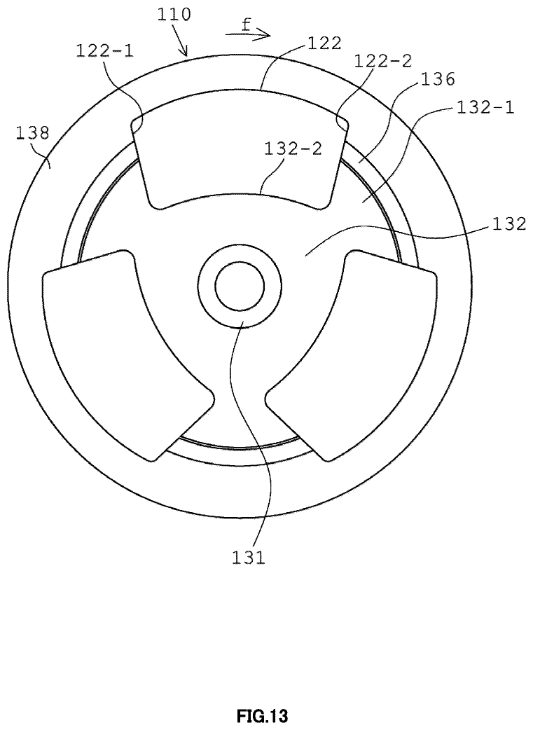

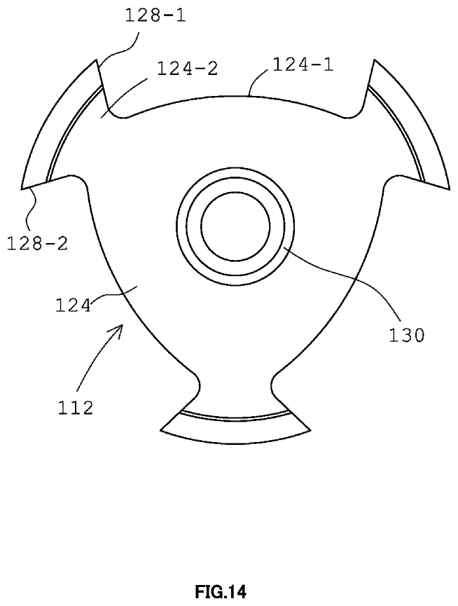

FIGS. 10 to 16 show the assembly for the torsional vibration reducing apparatus of the second embodiment according to the present invention, and the assembly comprises an input member 110, an output member 112, coil springs 114 and retainers 116 and 118, and retainers 116 and 118 include three groups of A, B and C. The input member 110 is a spline support which is different from the first embodiment. That is, the input member 110 comprises a central spline shaft 131 (also refer to FIG. 13) to spline-fit with the output shaft (not shown) of the prime mover, a supporting plate 132 (the second supporting plate of the present invention) integrated at the transmission-side end of the spline shaft 131, an axial-direction extending board 136 (the second axial-direction extending board of the present invention) in the axial direction and integrally extended to the transmission side in the circumferential direction and with equal intervals from the projective periphery 132-1 of the supporting plate 132, and a peripheral annular disc 138 integrally connected to the axial-direction extending board 136. The arc-shaped inner circumferential surface of the annular disc 138 between the annular disc 138 and the axial-direction extending board 136 neighboring in the circumferential direction is the guide portions 122 for the retainers 116 and 118. The guide portions 122 are provided three in the circumferential direction and have the equal intervals, and each of the guide portions 122 is separated in the circumferential direction and forms a pair of end faces 122-1 and 122-2 (the engaging section of the present invention) extending in the radial direction.

Although the matter that the output member 112 includes the spline shaft 130 for the spline fitting to the transmission input shaft-side is the same with the first embodiment, the matter that the overhang board 128 (the first axial-direction extending board of the present invention) which is a bending portion to the transmission side from the periphery 124-2 of the supporting plate 124 (the first supporting portion of the present invention) is extended to the transmission side in the axial direction is different from the first embodiment. The respective overhang boards 128 extend in the radial outer side and have the end faces 128-1 and 128-2 (the pressurization section of the present invention) opposite in the circumferential direction.

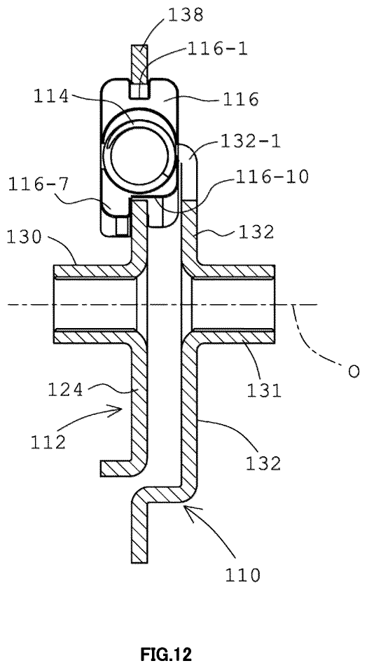

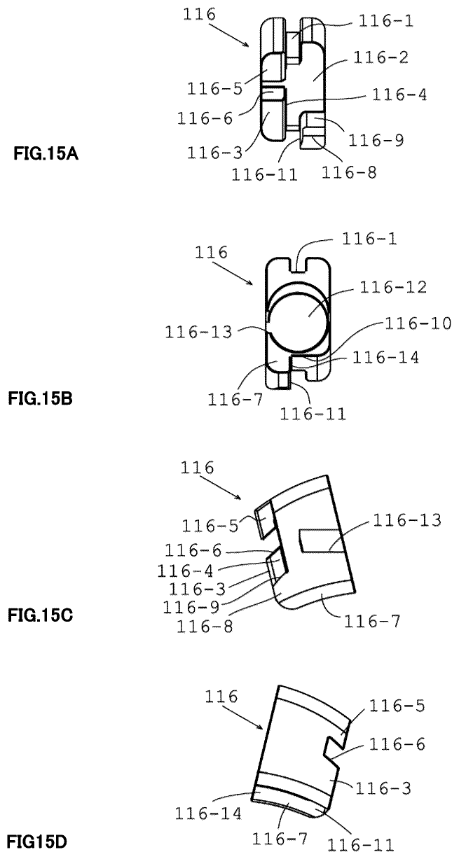

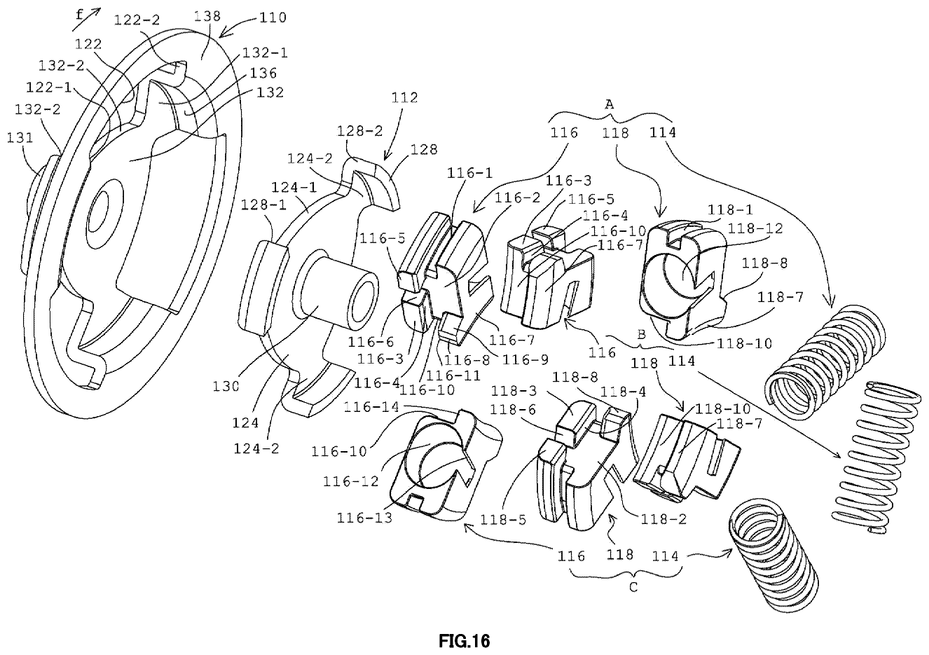

As shown in FIG. 16, the retainer 116 (also refer to FIGS. 15A to 15D) forms the guide groove 116-1 in the periphery and has the flat surface 116-2 (the pressure receiving section) formed as the flat surface at one end of the circumferential direction. The retainer 116 is further face-to-face biased to the transmission side, forms the narrow width periphery 116-7, backs from the periphery 116-7 to the prime mover side in the outer radial direction and represents the step surface 116-10 (refer to FIG. 12). The end portion of the periphery 116-7 opposite to the overhang board 128 represents the arc-shaped projection 116-8 from the flat surface 116-2, forms the step surface 116-10 (refer to FIG. 12) at the radial outer side of the arc-shaped projection 116-8, and forms the axial-direction supporting surface 116-11 which is, in the axial direction, perpendicular to the prime mover-side end face of the arc-shaped projection 116-8 and is extended to the radial direction. This construction of the retainer 116 is not substantially different from the retainer 16 of the first embodiment. Further, the matter that the axial-direction supporting surface 116-11 is an extension (the surface 116-11 and the surface 116-4 are positioned on the same surfaces) of the wall surface 116-14 being the border to the step surface 116-10 is also the same with the first embodiment. This is obvious from FIG. 15B and FIG. 15D, too.

The different matters between the retainer 116 of the second embodiment and the retainer 16 of the first embodiment are that: the trapezoidal projection 116-5 of the prime mover side is shortened, the trapezoidal projection 116-3 is established from the flat surface (the pressurization receiving surface) 116-2 so as to align in the radial inner side and the radial outer side of the trapezoidal projection 116-5 in place of the plate-like projection 16-3 of the retainer 16, the axial-direction supporting surface 116-4 is formed on the side surface of the transmission side of the trapezoidal projection 116-3, and the axial-direction groove 116-6 is represented between the trapezoidal projection 116-3 and the trapezoidal projection 116-5.

In the second embodiment, the guide groove 116-1 is fit to the guide portion 122 corresponding to the input member 110 in the assembled state. The outer-circumference projective portion 124-2 of the supporting plate 124 of the output member 112 is passed to the radial outer side between the trapezoidal projection 116-3 and the arc-shaped projection 116-8, and the overhang board 128 of the output member 112 makes contact with the flat surface 116-2 of the retainer 116 at one end face 128-1. Further, the arc-shaped projection of the retainer 116 is penetrated in the overhang board 128 of the output member 112 from the inner peripheral side (refer to FIG. 10), the circumferential direction-outer surface 116-9 of the arc-shaped projection 116-8 contacts with inner circumference surface of the overhang board 128.

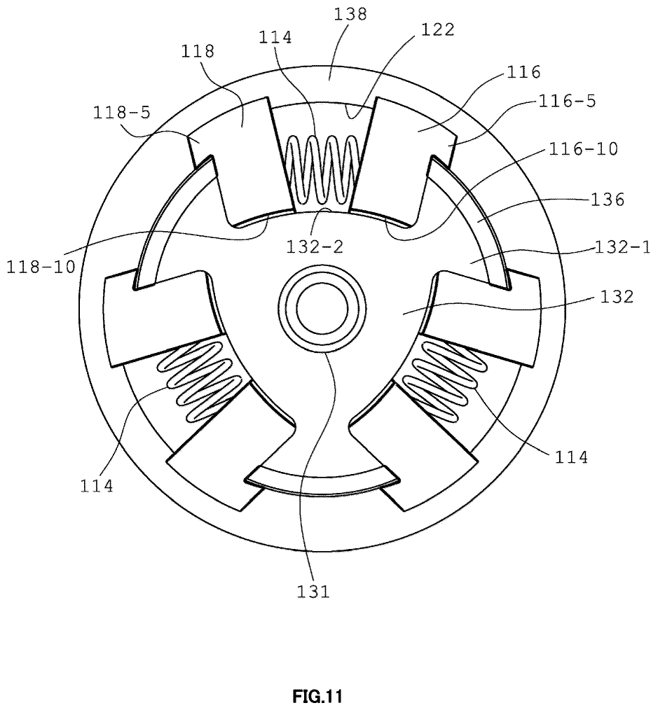

Regarding the retainer 116, the step surface 116-10 (also refer to the retainer 116 of the group B) are oppositely arranged on the circumference surface 132-2 (refer to FIGS. 11 and 13) of the supporting portion 132 of the input member 110 and on the circumference surface 124-1 of the supporting portion 124 of the input member 110 at the prime mover side in the inner circumferential surface. Further, in a case that the assembly of the second embodiment is applied to the torsional vibration reducing apparatus and in the neutral state without the rotational fluctuation between the input member 110 and the output member 112, the axial-direction extending board 136 (the second axial-direction extending board of the present invention) of the input member 110 is passed through the axial-direction groove 116-6 of the retainer 116, and one end face 122-1 of the guide portion 122 is made contact with the flat surface 116-2. Furthermore, the retainer 116 of the group C has the notch portion 116-13 at the transmission side of the supporting plate 124 and has a cylindrical bottomed recess 116-12 to contain an end portion of the coil spring 114 at the overhang board 128 and the separation-side end portion.

The construction of the retainer 118 being a pair of the retainer 116 is the same with the retainer 116 except for the symmetry. The guide groove 118-1, the inner periphery 118-7, the arc-shaped projection 118-8, the step surface 118-10 and the coil spring-containing recess 118-12 of the retainer 118 of the group Aarewell seen. Further, the flat surface 118-2 and the trapezoidal projections 118-3 and 116-5 established on the flat surface 118-2 of the retainer 118 of the group C are also well seen. In a case that the assembly of the second embodiment is applied to the torsional vibration reducing apparatus and in the neutral state without the rotational fluctuation between the input member 110 and the output member 112, the axial-direction extending board 136 of the input member 110 is passed through the axial-direction groove 118-6 of the retainer 118, and another end face 122-2 of the guide portion 122 is made contact with the flat surface 118-2.

The support of the retainer 116 of the assembly according to the second embodiment is performed for the input member 110 by fitting the guide portion 122 to the guide groove 116-1 and by supporting the retainer 116 to the input member 110 in the axial direction with the axial-direction opposite surface of the guide groove 116-1. For the output member 112, the periphery 124-2 of the supporting plate 124 is fit between the trapezoidal projection 116-3 and the arc-shaped projection 116-8, and the output member 112 is supported from the prime mover side by the first axial-direction supporting surface 116-4 of the trapezoidal projection 116-3 and from the transmission side by the second axial-direction supporting surface 116-11 of the arc-shaped projection 116-8. The radial direction support is performed by that: the annular disc 138 makes contact with the bottom surface of the guide groove 116-1, the arc-shaped projection 116-8 penetrates into the overhang board 128 from the radial inside, the circumference direction-outer surface 116-9 makes contact with the overhang board 128 from the radial inner side and the input member 110 and the output member 112 are sandwiched from the radial outer side and the radial inner side. That is, the overhang board 128 of the second embodiment also functions serving as the axial-direction extending plate of the present invention.

The axial direction support and the radial direction support of the input member 110 and the output member 112 by the retainer 118 are similarly performed, too.

The operation of the torsional vibration reducing apparatus configured by connecting the assembly of the second embodiment to the crank shaft at the input member 110-side and by connecting the assembly to the transmission at the output member 112-side will be explained below. In the neutral state that there is not the rotational fluctuation between the input member 110 and the output member 112, the end face 122-1 of the guide portion 122 in the input member 110 makes contact with the flat surface 116-2 regarding the retainer 116. At this time, the axial direction extending board 136 is contained in the axial-direction groove 116-6 between the trapezoidal projections 116-3 and 116-5. It is similar to the retainer 118, the end face 122-2 of the guide portion 122 is made contact with the flat surface 118-2, the axial-direction extending board 136 is contained in the groove 118-6 between the trapezoidal projections 118-3 and 118-5, and the load applied to the coil springs 114 at this time becomes a set value. In the neutral state, the end face 128-1 of the overhang board 128 makes contact with the flat surface 116-2 of the retainer 116, and the end face 128-2 of the overhang board 128 makes contact with the flat surface 118-2 of the retainer 118. The above state is also shown in FIG. 10.

In a case that the output member 112 is rotationally fluctuated in the forward rotational direction (the arrow f direction) to the input member 110, the overhang board 128 of the output member 112 maintains the state that the end face 128-1 positioned at the upstream in the rotational fluctuation direction makes contact with the flat surface 116-2 of the retainer 116, and the retainer 118 being the group maintains the state that the flat surface 118-2 makes contact with the end face 122-2 of the guide portion 122 of the input member 110. In this connection, the retainer 116 (which is fit to the guide portion 122 in the guide groove 116-1) is slid along the guide portion 122 in the forward rotational direction (the arrow f direction), the further compression from the set value of the coil springs 114 by the retainer 116 is aroused. Inversely, in a case that the output member 112 is rotationally fluctuated in the inverse direction (the opposite direction to the arrow f) to the input member 110, the overhang board 128 of the output member 112 maintains the state that the end face 128-2 positioned at the upstream in the rotational fluctuation direction makes contact with the flat surface 118-2 of the retainer 118, and the retainer 116 being the group maintains the state that the flat surface 116-2 makes contact with the end face 122-1 of the guide portion 122 of the input member 110. Consequently, the retainer 118 (which is fit to the guide portion 122 in the guide groove 118-1) is slid along the guide portion 122 in the opposite direction (the opposite direction to the arrow f), and the compression of the coil springs 114 is further increased from the set value by the retainer 118.

Since the input member 110 has the supporting plate 132 in the present invention, it is possible to configure that the opposite surfaces to the retainers 116 and 118 of the supporting plate 132 makes function as the axial-direction supporting surface of the retainers 116 and 118.

Further, through the explanation on the first and second embodiments, the configuration that the input members 10 and 110 represent the annular portion at the periphery and the output members 12 and 112 comprise the central supporting plates 24 and 124 and the overhang boards 28 and 128, is shown. However, it is possible to realize the replacement configuration that the input member comprises the central supporting plates and the circumference overhang boards and the output member is formed by the annular portion in the periphery. This is obvious to the skilled person and is, of course, included in the scope of the present invention.

### Explanation of Reference Numerals

10; 110—input member
12; 112—output member
14; 114—coil spring
15, 18; 116-1, 118-1—retainer
16, 16-1; 116-1, 118-2—guide groove
16-2, 18-2; 116-2, 118-2—flat surface (pressure receiving section of the present invention)
16-3, 18-3—plate-like projection (the first axial-direction supporting-face forming portion of the present invention)
116-3, 118-3—trapezoidal projection (the first axial-direction supporting-surface forming portion of the present invention)
16-4, 18-4; 116-4, 118-4—axial-direction supporting surface
16-5, 18-5; 116-5, 118-5—trapezoidal projection
16-6, 18-6—longitudinal groove
116-6, 118-6—axial-direction groove
16-7, 18-7; 116-7, 118-7—inner periphery (circumferential-direction wall portion of the present invention)
16-8, 18-8; 116-8, 118-8—arc-shaped projection (the first axial-direction supporting-surface forming portion and the circumferential-direction supporting-surface forming portion of the present invention)
16-11, 18-11; 116-11, 118-11—axial-direction supporting surface
16-12, 18-12; 116-12, 118-12—bottomed recess
16-13, 18-13; 116-13, 118-13—notch portion
16-14, 18-14; 116-14, 118-14—supporting-plate opposite wall surface of the inner periphery
22, 122—guide portion
22-1, 22-2; 122-1, 122-2—end face of guide portion (engaging section of the present invention)
24; 124—supporting plate (the first supporting plate of the present invention)
24-1; 124-1—circumference surface of supporting plate
26—axial-direction extending board (the first axial-direction extending board of the present invention)
28; 128—overhang board (the first axial-direction overhang board of the present invention)
28-1, 28-2; 128-1, 128-2—end face of overhang board (pressurization section of the present invention)
30; 130—spline shaft
131—spline shaft
132—supporting plate (the second supporting plate of the present invention)
136—axial-direction extending board (the second axial-direction extending board of the present invention)
138—annular disc
O—rotation central line

1-9. (canceled)

10. An assembly for a torsional vibration reducing apparatus that comprises an input member to be rotatably connected to driving side, an output member which has a same rotation central line to said input member and is rotatably connected to driven side, and coil springs arranged in a circumferential direction with intervals between said input member and said output member; and reduces a rotational fluctuation at a driving time of said output member of said driven side based on said input member of said driving side by an elastic deformation of said coil springs in a circumferential direction:
wherein either one of said input member and said output member is faced to said coil springs with equal intervals in a circumferential direction and has a same rotation central line to said input member and said output member, and includes an annular disc which has an arc-shaped guide portion in an inner periphery having engaging sections at both sides in a circumferential direction; and another one of said input member and said output member includes a central supporting plate, axial-direction extending boards formed to be extended in an axial direction at one side of a radial outer side of said supporting plate, overhang boards which extend between said coil springs closing to radial outer side of said supporting plate in a circumferential direction and has pressurization sections at both sides in a circumferential direction, and retainers mounted on both sides in circumferential direction of said respective coil springs,
wherein said respective retainers comprise: a bottomed recess which is formed at a corresponding overhang board and a circumferential-direction separation-side end portion, and contains and supports a circumferential-direction end portion closing to said coil springs; a guide groove which is extended to in a circumferential direction at outer circumferential side, includes a pair of side surfaces in a circumferential direction opposite to an axial direction and a bottom in a circumferential direction, and is freely fit in a circumferential direction to an arc-shaped guide portion; a circumferential-direction wall portion which is biased to an axial-direction same-side for an axial-direction extending board mounting-side of said supporting plate at inner peripheral side by leaving an opposite surface to a supporting-plate circumference surface, and which is oppositely formed on said supporting plate in an axial direction; a pressure receiving section which is flatly formed on a circumferential-direction end portion closing to said overhang board; a first axial-direction supporting-surface forming portion to form a first axial-direction supporting-surface established on said pressure receiving section; a second axial-direction supporting-surface forming portion which is established separated from said first axial-direction supporting-surface forming portion in an axial direction, and forms a second axial-direction supporting-surface on an extension of a supporting-surface plate opposite-surface of said circumferential-direction wall portion; and a circumferential-direction supporting-surface forming portion which is biased to radial inner side and is established on said pressure receiving section while biased to a mounting side of said axial-direction extending board to said supporting plate and an axial-direction same side, and forms said circumferential-direction supporting-surface in a radial outer side, and
wherein said respective retainers make contact with said engaging section and said pressurization section opposite to said pressure receiving section, for said supporting plate, are made contact with said first axial-direction supporting-surface from one side of an axial direction and are made contact with said second axial-direction supporting-surface from another side, said circumferential-direction supporting surface is made contact with said axial-direction extending board from a radial inner side and said respective coil springs are compressed to set loads between said retainers in a circumferential direction so that said retainers themselves support said input member and said output member.

11. The assembly according to claim 10,
wherein said overhang boards are formed so as to extend to a radial outer side from said axial-direction extending board,
wherein said first axial-direction supporting-surface forming portion is established from said pressure receiving section and is formed as plate-like projection to be terminated on a way from a retainer circumference surface to radial inner side, and said first axial-direction supporting surface is formed by axial-direction separation side-surface from said supporting plate of said plate-like projection,
wherein said second axial-direction supporting-surface forming portion and said circumferential-direction supporting-surface forming portion are integrated and are formed as arc-shaped projections established at said pressure receiving section separated from plate-like projections in a radial inner side and biased to axial-direction separation side from said supporting plate, and said second axial-direction supporting-surface is formed by axial-direction closing-side end face of supporting plate closing side of said arc-shaped projection and said circumferential-direction supporting-surface is formed by radial outer side surface of said arc-shaped projection,
wherein said overhang board makes contact with said axial-direction supporting portion in said plate-like projection and said supporting plate makes contact with said second axial direction supporting surface in said arc-shaped projection, and
wherein said arc-shaped projection penetrates into said axial-direction extending board from a radial inner side and said circumferential-direction supporting-surface makes contact with inner circumferential surface of said axial-direction extending board.

12. The assembly according to claim 11,
wherein trapezoidal projection is established on said pressure receiving section so as to terminate on a way from a circumference surface by biasing in parallel with said plate-like projection in a radial direction and to supporting plate closing side, and
wherein longitudinal groove opened to said guide groove is formed between said plate-like projection and said trapezoidal projection, in a neutral state that there is no rotational fluctuation between said input member and said output member, a circumferential-direction end portion corresponding to said arc-shaped guide portion of said annular disc is contained in said longitudinal groove and makes contact with said pressure receiving section.

13. The assembly according to claim 10,
wherein said overhang boards (in following, a first overhang boards) in said another one of said input member and said output member are extended in an axial direction toward a separation side from said first overhang boards so as to double use said axial-direction extending board (in following, a first axial-direction extending board),
wherein said one of said input member and said output member comprises, in addition to said annular disc, a second supporting plate aligned to said supporting plate (in following, a first supporting plate), a second overhang board aligned to said input member and said first overhang board in an axial direction, and a second axial-direction extending board that is integrally connected to said second supporting plate to a radial-direction overhang inner-edge between said arc-shaped guide portions neighboring to said annular disc in a circumferential direction,
wherein said first axial-direction supporting-surface forming portion biases in a radial inner side and is formed in said pressure receiving section as said trapezoidal projection biased and established at said first supporting plate closing side in an axial direction, and said first axial-direction supporting surface is formed by said first supporting plate of said trapezoidal projection and separation-side surface,
wherein said second axial-direction supporting-surface forming portion and said circumferential-direction supporting-surface forming portion are integrated and are formed as said arc-shaped projection separated from said trapezoidal projection in an axial direction and established at said pressure receiving section by biasing to said first supporting plate and separation side, and said circumferential-direction supporting-surface is formed by said radial outer surface of said arc-shaped projection, and
wherein said outer circumferential-side end portion of said first supporting plate makes contact with said first axial-direction supporting surface and said second axial-direction supporting surface between said trapezoidal projection and said arc-shaped projection, said arc-shaped projection penetrates into said first axial-direction overhang board from radial inner side, and said circumferential-direction supporting-surface makes contact with inner circumferential surface of said axial-direction extending board.

14. The assembly according to claim 13,
wherein a second trapezoidal projection is established on said pressure receiving section aligned to said trapezoidal projection (in following, a first trapezoidal projection) and with intervals so as to terminate face-to-face to a circumference surface, an axial-direction groove is formed between said first trapezoidal projection and said second trapezoidal projection, and said second axial-direction overhang plate is contained in said axial-direction groove in a neutral state without said rotational fluctuation between said input member and said output member.

15. The assembly according to claim 10,
wherein said circumference surface of said supporting plate among overhang boards neighboring in a circumferential direction is separated from an inner circumferential surface of said arc-shaped guide portion as separating from an edge rim of said overhang board to an intermediate portion to an edge rim opposite in a circumferential direction.

16. The assembly according to claim 10,
wherein said retainers form notch portions extended to said pressure receiving section side from opening edge rim of said bottomed recesses at, at least, one side wall surface in an axial direction.

17. The assembly according to claim 10,
wherein said retainers are plastic-integral molded products by an injection molding type.

18. The assembly according to claim 10,
wherein said input member and said output member are press-formed products made by steel plates.
